(19) United States
(12) Patent Application Publication
(10) Pub. No.: US 2013/0181381 A1
(43) Pub. Date: Jul. 18, 2013

(54) POLYMER COMPOSITE MATERIAL WITH BIOCIDE FUNCTIONALITY

(71) Applicants: Ralf Dujardin, Dusseldorf (DE); Jochen Norwig, Leverkusen (DE); Koen Van Den Eynde, Monheim am Rhein (DE); Heinz Pudleiner, Krefeld (DE)

(72) Inventors: Ralf Dujardin, Dusseldorf (DE); Jochen Norwig, Leverkusen (DE); Koen Van Den Eynde, Monheim am Rhein (DE); Heinz Pudleiner, Krefeld (DE)

(73) Assignee: BAYER INNOVATION GMBH, LEVERKUSEN (DE)

(21) Appl. No.: 13/809,570

(22) PCT Filed: Jul. 13, 2011
(86) PCT No.: PCT/EP11/61957

§ 371 Date: Mar. 29, 2013

Related U.S. Application Data
(60) Provisional application No. 61/364,923, filed on Jul. 16, 2010.
(60) Provisional application No. 61/365,420, filed on Jul. 19, 2010.

(51) Int. Cl. A01N 25/10; A01N 25/34

(52) U.S. Cl. CPC A01N 25/10; A01N 25/34
USPC 264/540; 424/411; 424/409; 504/360; 504/361

(57) ABSTRACT

The present invention relates to a novel process for preparing organically modified sheet silicates in high purity. The process of the invention uses ion exchange resins for this purpose.

The present invention relates to polymer composite materials with biocide functionality, methods for producing such polymer composite materials and their use, in particular for agriculture.

Plastics articles are used in agriculture for increased yields, earlier harvests, water conservation and protection of food products. Examples for such plastic articles in crop production are pots, trays, agricultural films, bags and nets.

Agricultural films are used extensively throughout the world because of the many advantages they provide, including retarded weed growth, increased soil retention of moisture and heat reduction, and reduced soil erosion by winds and rain. For such purposes it is possible to realize various types of coverings of the crops with agricultural films, for instance arranged in the form of tunnels or stretched out directly onto planted soil. In addition agricultural films are used in agricultural production in combination with additional pesticides to achieve high-yield crop yields.

Agricultural cultivations protected by plastic coverings or films can be protected from vegetable and animal pests (parasites) if the coverings or films are treated, at least on the face thereof to be placed in contact with the cultivation, with one or more pesticides. In WO2009/012887A1 a polymer composite material with biocide functionality, preferable for the use in agriculture, is disclosed. The composite material comprises at least one base polymer compound and at least one biocide active ingredient, wherein the biocide active ingredient is an organic biocide that can be emitted from the polymer composite material by diffusion and/or osmosis. The biocide active ingredient is incorporated into one or multiple coating layers. Additional coating layers can be used for barrier, protection or diffusion control. The manufacturing process for these composite materials with biocide functionality is at least a two step process: firstly a film of the polymer material is made which secondly is coated with an active ingredient.

A person skilled in the art can expect that the drying of aqueous or solvent based multilayer coatings will be carried out at elevated temperatures but below 70° C. to stay below the softening point, called glass transition temperature of the typical used polymeric substrates in agricultural films, like Polyethylene, Polypropylene, Ethylenevinylalcohol or Polyamides. Therefore the coating layers are dried by contact with air or other gaseous media maintained at an elevated temperature, but at high throughput speed which cause short retention times at elevated temperatures, e.g. like described in WO89/05477. The coatings can be applied to the films e.g. by curtain coating allowing the manufacturing of multilayer assemblies up to 20 individual coatings at high speed of 300-600 m/min. Therefore thermolabile pesticides can be applied by coating processes without thermal degradation or evaporation. Disadvantage of such composite materials is their reduced pliability caused by the combination of an elastic polymer film with a stiff coating and the high manufacturing costs because of the energy required to evaporate the solvent required for drying the coating at high speeds.

To overcome the disadvantages previously quoted it is desirable to produce a polymer composite with biocide functionality by incorporation of the biocides directly in the polymeric film production instead of a coating film under the perquisite to prevent thermal degradation of the pesticides.

Most pesticides are made with the built-in ability to degrade as fast as possible not to harm environment or not to accumulate in it. For example, Chitra Sood et al. observed degradation of pesticides in green tea during processing at temperatures in the range of 65 to 100° C. (Journal of the Science of Food and Agriculture 84:2123-2127 (online: 2004), DOI: 10.1002/jsfa.1774). An abundance of literature is available dealing with the thermal decomposition of pesticides during gas chromatographic analysis at temperatures up to 220° C.

A common method to make agricultural films is extrusion, either cast extrusion or blow mold extrusion. Cast extrusion is a high volume manufacturing process in which raw plastic material is melted and formed into a continuous profile inside an extruder. Plastic beads will enter the extrusion line and will be heated to the desired melt temperature of the molten plastic, which can range from 200° C. to 275° C. depending on the polymer. The blown film extrusion process involves extruding a tube of molten polymer through a die and inflating to several times its initial diameter to form a thin film bubble. This bubble is then collapsed and used as a lay-flat film or can be made into bags. Blown films generally have a better balance of mechanical properties, e.g. pliability, than e.g. cast or extruded films because they are drawn in both the transverse and machine directions. Mechanical properties of the thin film include tensile and flexural strength, and toughness. Blown films also require lower melting temperatures than cast extrusion. Measured at the die opening, the temperature of polyethylene cast film is about 220° C., where as the temperature of polyethylene blown film is about 135° C. (EP0278569A2).

Coextrusion—which means extruding one or more materials simultaneously through a single die—allows to improve the efficiency of blown film extrusion. The orifices in the die are arranged such that the layers merge together before cooling. In contrast to cast film extrusion, where the individual layers are usually combined in a multilayer adaptor and distributed across the width of a cast film die, blown film coextrusion operates with separate melt channels. The advantage of the separate melt channels lies in the fact that raw materials of different viscosities are easier to combine, with the tolerances of the individual layers being mostly determined by the design of the melt channels.

Multilayer films made by blown film coextrusion are used as barrier agricultural fumigation films (Acta Horticulture 382, Pages 56-66, 1995). Typically, a fumigant such as methylbromide (MeBr) is injected into crop beds about two or three weeks before planting via shanks in the soil Immediately after the fumigant is injected, a fumigation cover film is placed on top of the bed in order to avoid emissions of the fumigant. Coextrusion blown films called Hytibar showed a minimum permeability coefficient for methyl bromide. However, coextrusion blown films comprising biocide active ingredients are not disclosed in prior art.

Therefore, it is an object of the present invention to provide a polymer composite material, preferably for the use in agriculture and/or horticulture, which can have a variety of biocide functionalities and which can be manufactured more easily, more efficiently and at lower costs than comparable films from prior art without thermal decomposition of the biocides.

It is another object of the present invention to provide a method for the production of such a polymer composite material.

This object is solved by a polymer composite material made by blown film coextrusion, the material comprising at least two layers, whereas at least one biocide active ingredient is dispersed within at least one of the layers.

Under the term biocide active ingredient there are all chemical substances understood which are capable of killing different forms of living organisms and/or viruses used in fields such as medicine, agriculture, and forestry, particularly in agriculture and/or horticulture.

In a preferred embodiment of the present invention the biocide active ingredient or a combination of biocide active ingredients is incorporated in at least one of the layers of the polymer composite material in form of a molecular dispersion. Like that, an even and defined distribution in the layer is achieved.

The whole setup of the polymer composite material is obtained by a single blown film coextrusion process. This is a great advantage over the polymer composite materials known from prior art, since the polymer composite material according to the present invention can be manufactured much easier and at lower costs.

Therefore another subject of the present invention is a process for manufacturing a polymer composite material, characterized in that at least a first polymer and a second polymer are coextruded through a single extrusion head (die), whereas air is injected through a hole in the center of the die, and the extruded melt is expanded into a bubble, whereas at least one of the polymers comprises at least one biocide active ingredient.

Since blown films require lower melting temperatures than cast extrusion films one or more active ingredients can be added to one or more polymers before or during the melting and/or extrusion process in order to finely disperse the ingredient in the polymer melt.

The one or more active ingredient are preferably added as a premix out of one or more polymers with an active ingredient content between 0.1 and 40%.

Therefore another subject of the present invention is a process for manufacturing the premix by first milling polymer powder of one or more polymers with a solid active ingredient powder or a liquid active ingredient at temperatures between −20° C. and 40° C. and second by compacting the premix powder to denser beads.

The premix powder or the denser beads can be directly fed into the blown film extrusion process without thermal degradation of the pesticides.

Each layer of the polymer composite material is made by putting the ingredients of each respective layer in a hopper, which releases the mixture of ingredients into an extruder. The extruder heats up the mixture and puts it under pressure, and propels it through a die. The top of the die has circles of capillary openings through which the material flows. The number of circles is equal to the number of layers of the film. The circles are placed very close to each other, and when the heated mixture is pushed out of the capillary openings, the material slightly expands, thus bonding together with the other layers. When two materials are too alien to properly adhere to another, e.g. such as polyamide and polyethylene resins, a layer containing a tie-layer-additive, which can bond with both the polyamide and polyethylene resin layers, can be positioned between the two alien materials to facilitate adhesion of the layers, thereby increasing the strength of the film.

The different layers of the polymer composite material according to the present invention serve different functions. A minimum setup contains two layers. The first layer is a supporting layer for the mechanical stability of the setup. This supporting layer can also serve as a barrier layer, e.g. for avoiding emissions of fumigants. The second layer serves as depot of biocide active ingredients. The second layer usually is brought into contact with the soil and/or cultivation (lower layer). But it is also possible to put the second layer containing one or more biocide active ingredients on top, e.g. in order to protect plants piercing through the polymer composite material against pests scrabbling over the top layer.

In a preferred embodiment of the present invention the polymer composite material comprises three layers—one core layer and two outer layers sandwiching the core layer. At least one of the outer layers comprises one or more biocide active ingredients. The core layer serves as a supporting layer and represents 60 to 90% of the whole setup.

The one or more layers containing one or more biocide active ingredients should be made very thin. In one preferred embodiment of the present invention a layer containing an biocide active ingredient has a thickness of 1/10 of the total composite material thickness. Such a thin layer leads to a reduced thermal exposure of the active ingredient during the manufacturing process. Additionally the overall amount of active ingredient can be reduced because in case of a thinner layer there are less residual amounts remaining in the layer.

In order to further reduce the thermal stress to the biocide active ingredient in one or more outer layers of the plastic article, the outer layers are intensively cooled e.g. by air stream after the blow molded film leaving the molding head.

The polymer materials for the outer layers of the polymer composite material can be selected from the group consisting of polyolefins such as polyethylene (such as for example LLDPE, LDPE, MDPE, HDPE) which can optionally comprise commonly used pigments, UV stabilizers, UV absorbers, IR absorber and light diffuser. The polymer materials for the supporting layer of the polymer composite material can be polyethylene terephthalate, polyamide, polyolefins such as polyethylene (such as for example LDPE, HDPE) polypropylene, polystyrene, polyethylene-vinyl-alcohol and polyurethane which can optionally comprise commonly used pigments, UV absorbers and IR absorber. These materials show the required resistance to outdoor exposure and can be used in form of flexible films as wells as molded inflexible articles like trays and pots.

In a preferred embodiment according to the present invention the supporting layer is made from HDPE, whereas one or two outer layers are made from LDPE or LLDPE or blends of LDPE and LLDPE, whereas the one or two outer layers comprise one or more biocide active ingredients.

The polymer composite material according to the present invention can show any thickness and width suitable for a particular agricultural or medicinal application.

Typically, the different layers of the polymer composite material according to the present invention have a thickness of 10 to 250 μm, preferably 10 to 150 μm, and more preferably of 20 to 120 μm, and even more preferably 20-50 μm.

In another embodiment of the present invention the polymer materials, at least the polymer material of the supporting layer, can withstand at least 12 months of outside exposure to sunlight and weather. By having such a minimum resistance the polymer compound is sure to fulfil the requirements of the intended use in agriculture as fumigation or mulch film or as reusable trays for seedling production (nursery trays), for instance.

Likewise, the polymer composite material should not be biodegradable or water soluble. The function of the polymer composite material should be usable over a long period of time so that for example no weeds, pests or fungi can harm the plants as they grow in a field under the protection of the polymer composite biocide material. Furthermore, the articles of the intended use like films and trays should be useable over a wider period of time and should not degrade in one planting and harvesting season, for example. Especially the mechanical stability of the films should be kept high because the film should preferably be retractable from the field and reusable.

It is within the scope of the inventive polymer composite material that additional pigments, additives and fillers can be used which are widely known to the skilled person.

A tie-layer additive can be used in order to facilitate adhesion between varying materials. UV additives prevent premature degradation due to UV-radiation.

It is also possible to use one or more degradant in one or more layers comprising one or more biocide active ingredient. A degradant is a substance which facilitates or accelerates the degradation of the layer comprising that degradant. The degradation of the layer facilitates or accelerates the release of the biocide active ingredients. Examples of suitable degradants are metal carboxylates, inclusing carboxylates containing aluminium, antimony, barium, bismuth, cadmium, cerium, chromium, cobalt, copper, gallium, iron, lanthanum, lead, lithium, magnesium, manganese, mercury, molybdenum, nickel, potassium, rare earths, silver, sodium, strontium, tin, tungsten, vanadium, yttrium, zinc, or zirconium, and combinations thereof Some preferred metal carboxylates are ferric stearate, iron III stearate, ferric 12-hydroxy-stearate, cobalt stearate, manganese stearate, and vanadium staerate. The degradants may also comprise a combination of a metal carboxylate and an aliphatic polyhydroxycarboxyl acid.

It will be understood by persons skilled in the art that, in addition to controlling the degradation rate and total degradation time of the polymer composite material, it is desirable to also control the shelf life of the polymer composite material. Therefore, in addition to the degradant, it is desirable to include antioxidants and/or UV stabilizers, in order to control the shelf and service life.

By the incorporation of the biocide active ingredient into repeating layers a control of diffusion and/or osmosis rates can be achieved. Apart from that, different biocide active ingredients can be incorporated in different layers. The present invention, however, also relates to embodiments wherein a mixture of at least two biocide active ingredients are incorporated into one layer. Depending on the plant growth and the possible seasonally changing requirements in terms of pests, fungi, and the like, a tailored approach to biocide treatment can be provided.

In a preferred embodiment of the present invention the polymer composite material contains pesticides with different mode of action—systemic and non-systemic within the outer layers. Systemic pesticides should be included in the layer facing later-on the soil whilst non-systemic pesticides shall be included in the outer top layer. Therefore the plastic articles can protect both the plant and the fruits.

The organic biocide is preferably selected from the group consisting of pesticides, herbicides, insecticides, algicides, fungicides, moluscicides, miticides, and rodenticides. Moreover, the organic biocide can even more preferably be selected from the group consisting of germicides, antibiotics, antibacterials, antivirals, antifungals, antiseptics, antiprotozoals, and antiparasites.

In another preferred embodiment of the invention the organic biocide is selected from the group of antiseptics and/or disinfectants for medical use and food.

As the regulations for chemical substances being considered safe for the use in the agricultural, food and medical field are constantly changing, such organic biocide active ingredients are most preferred for the present invention which comply with the actual official regulations for chemical substances and especially for antiseptics and disinfectants in those fields. Especially those substances which are listed in the European Biocidal Products Directive (98/8/EC) by the European Commission are preferably used as biocide active ingredients according to the present invention.

In another preferred embodiment of the present invention the organic biocide is selected from the group comprising of acetamides and anilides herbicides, thiocarbamate herbicides, chlorphenoxy herbicides, dipyridyl herbicides, dinitrocresolic herbicides, cyclohexyloxim herbicides, phosphonate herbicides, traizolon herbicides, urea herbicide derivatives and/or mixtures thereof.

Particular herbicides according to the present invention are selected from the group comprising acetochlor, acibenzolar, acibenzolar-s-methyl, acifluorfen, acifluorfen-sodium, aclonifen, alachlor, allidochlor, alloxydim, alloxydim-sodium, ametryn, amicarbazone, amidochlor, amidosulfuron, aminopyralid, amitrole, ammoniumsulfamat, ancymidol, anilofos, asulam, atrazine, azafenidin, azimsulfuron, aziprotryn, BAH-043, BAS-140H, BAS-693H, BAS-714H, BAS-762H, BAS-776H, BAS-800H, beflubutamid, benazolin, benazolin-ethyl, bencarbazone, benfluralin, benfuresate, bensulide, bensulfuron-methyl, bentazone, benzfendizone, benzobicyclon, benzofenap, benzofluor, benzoylprop, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, carfentrazone, carfentrazone-ethyl, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chlorid, chlornitrofen, chlorophthalim, chlorthal-dimethyl, chlorotoluron, chlorsulfuron, cinidon, cinidon-ethyl, cinmethylin, cinosulfuron, clethodim, clodinafop clodinafop-propargyl, clofencet, clomazone, clomeprop, cloprop, clopyralid, cloransulam, cloransulam-methyl, cumyluron, cyanamide, cyanazine, cyclanilide, cycloate, cyclosulfamuron, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), diallate, dicamba, dichlobenil, dichlorprop, dichlorprop-p, diclofop, diclofop-methyl, diclofop-p-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-p, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, eptc, esprocarb, ethalfluralin, ethametsulfuron-methyl, ethephon, ethidimuron, ethiozin, ethofumesate, ethoxyfen, ethoxyfen-ethyl, ethoxysulfuron, etobenzanid, F-5331, i.e. N-[2-chlor-4-fluor-5-[4-(3 fluorpropyl)-4,5-dihydro-5-oxo-1H-tetrazol-1-yl]-phenyl]-ethansulfonamid, fenoprop, fenoxaprop, fenoxaprop-p, fenoxaprop-ethyl, fenoxaprop-p-ethyl, fentrazamide, fenuron, flamprop, flamprop-m-isopropyl, flamprop-m-methyl, flazasulfuron, florasulam, fluazifop, fluazifop-p, fluazifop-butyl, fluazifop-p-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr, fluroxypyr-meptyl, flurprimidol, flurtamone, fluthiacet, fluthiacet-methyl, fluthiamide, fomesafen, foramsulfuron, forchlorfenuron, fosamine, furyloxyfen, gibberellinic acid, glufosinate, 1-glufosinate, 1-glufosinate-ammonium, glufosinate-ammonium, glyphosate, glyphosate-isopropylammonium, H-9201, halosafen, halosulfuron, halosulfuron-methyl, haloxyfop, haloxyfop-p, haloxyfop-ethoxyethyl, haloxyfop-p-ethoxyethyl, haloxyfop-methyl, haloxyfop-p-methyl, hexazinone, hnpc-9908, HOK-201, HW-02, imazamethabenz, imazamethabenz-methyl, imazamox, imazapic, imazapyr, imazaquin, imazethapyr, imazosulfuron, inabenfide, indanofan, indolacetic acid (IAA), 4-indol-3-yl-butanoic acid (IBA), iodosulfuron, iodosulfuron-methyl-sodium, ioxynil, isocarbamid, isopropalin, isoproturon, isouron, isoxaben, isoxachlortole, isoxaflutole, isoxapyrifop, IDH-100, KUH-043, KUH-071, karbutilate, ketospiradox, lactofen, lenacil, linuron, maleinic acid hydrazid, MCPA, MCPB, MCPB-methyl, -ethyl and -sodium, mecoprop, mecoprop-sodium, mecoprop-butotyl, mecoprop-p-butotyl, mecoprop-p-dimethylammonium, mecoprop-p-2-ethylhexyl, mecoprop-p-kalium, mefenacet, mefluidide, mepiquat-chlorid, mesosulfuron, mesosulfuron-methyl, mesotrione, methabenzthiazuron, metam, metamifop, metamitron, metazachlor, methazole, methoxyphenone, methyldymron, 1-methylcyclopropen, methylisothiocyanat, metobenzuron, metobenzuron, metobromuron, metolachlor, s-metolachlor, metosulam, metoxuron, metribuzin, metsulfuron, metsulfuron-methyl, molinate, monalide, monocarbamide, monocarbamide-dihydrogensulfat, monolinuron, monosulfuron, monuron, MT 128, MT-5950, i.e. N-[3-chlor-4-(1-methylethyl)-phenyl]-2-methylpentanamide, NGGC-011, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitrophenolat-sodium (mixture of isomers), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazol, paraquat, paraquat-dichlorid, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazol, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron-ethyl, pyrazoxyfen, pyribambenz, pyribambenz-isopropyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-p, quizalofop-p-ethyl, quizalofop-p-tefuryl, rimsulfuron, secbumeton, sethoxydim, siduron, simazine, simetryn, SN-106279, sulcotrione, sulfallate (cdec), sulfentrazone, sulfometuron, sulfometuron-methyl, sulfosate (glyphosate-trimesium), sulfosulfuron, SYN-523, SYP-249, SYP-298, SYP-300, tebutam, tebuthiuron, tecnazene, tefuryltrione, tembotrione, tepraloxydim, terbacil, terbucarb, terbuchlor, terbumeton, terbuthylazine, terbutryn, th-547, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triallate, triasulfuron, triaziflam, triazofenamide, tribenuron, tribenuron-methyl, trichlor acetic acid (tca), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-p, vernolate, ZJ-0166, ZJ-0270, ZJ-0543, ZJ-0862 , as well as the following compounds

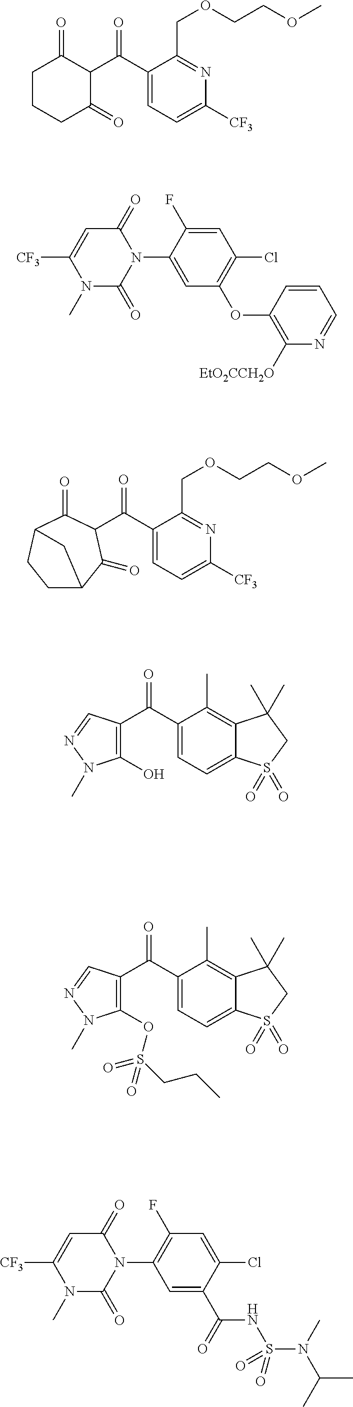

In another preferred embodiment of the present invention the organic biocide is selected from the group comprising antibiotics insecticides cyclodien insecticides, insect growth regulators, carbamate insecticides, nicotenoide insecticides, pyrethroid herbicides, oxadiazine insecticides, organophosphorus insecticides and/or mixtures thereof.

The following insects may be mentioned as examples and as preferred—but without any limitation:

Beetles, such as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus; Hymenopterons, such as Sirex juvencus, Urocerus gigas, Urocerus gigas taignus, Urocerus augur; Termites, such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus; Bristletails, such as Lepisma saccharina.

Particular insecticides according to the present invention are selected from the group comprising acetylcholinesterase (AChE) inhibitors such as for example carbamates, e.g. alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, and xylylcarb; or organophosphates, e.g. acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl, O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, and imicyafos. GABA-gated chloride channel antagonists such as for example organochlorines, e.g. camphechlor, chlordane, endosulfan, gamma-HCH, HCH, heptachlor, lindane, and methoxychlor; or fiproles (phenylpyrazoles), e.g. acetoprole, ethiprole, fipronil, pyrafluprole, pyriprole, and vaniliprole. Sodium channel modulators/voltage-dependent sodium channel blockers, such as for example pyrethroids, e.g. acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (-1R- isomer), tralomethrin, transfluthrin, ZXI 8901, pyrethrin (pyrethrum), eflusilanat; DDT; or methoxychlor. Nicotinergic acetylcholine receptor agonists/antagonists such as for example chloronicotinyls, e.g. acetamiprid, clothianidin, dinotefuran, imidacloprid, imidaclothiz, nitenpyram, nithiazine, thiacloprid, thiamethoxam, AKD-1022, nicotine, bensultap, cartap, thiosultap-sodium, and thiocylam. Allosteric acetylcholine receptor modulators (agonists) such as for example spinosyns, e.g. spinosad and spinetoram. Chloride channel activators, such as for example mectins/macrolides, e.g. abamectin, emamectin, emamectin benzoate, ivermectin, lepimectin, and milbemectin; or juvenile hormone analogues, e.g. hydroprene, kinoprene, methoprene, epofenonane, triprene, fenoxycarb, pyriproxifen, and diofenolan. Active ingredients with unknown or non-specific mechanisms of action such as for example gassing agents, e.g. methyl bromide, chloropicrin and sulfuryl fluoride; selective antifeedants, e.g. cryolite, pymetrozine, pyrifluquinazon and flonicamid; or mite growth inhibitors, e.g. clofentezine, hexythiazox, etoxazole. Oxidative phosphorylation inhibitors, ATP disruptors such as for example diafenthiuron; organotin compounds, e.g. azocyclotin, cyhexatin and fenbutatin oxide; or propargite, tetradifon. Oxidative phoshorylation decouplers acting by interrupting the H proton gradient such as for example chlorfenapyr, binapacryl, dinobuton, dinocap and DNOC. Microbial disruptors of the insect gut membrane such as for example Bacillus thuringiensis strains. Chitin biosynthesis inhibitors such as for example benzoylureas, e.g. bistrifluron, chlorfluazuron, diflubenzuron, fluazuron, flucycloxuron, flufenoxuron, hexaflumuron, lufenuron, novaluron, noviflumuron, penfluron, teflubenzuron or triflumuron. Buprofezin. Moulting disruptors such as for example cyromazine. Ecdysone agonists/disruptors such as for example diacylhydrazines, e.g. chromafenozide, halofenozide, methoxyfenozide, tebufenozide, and JS-118; or azadirachtin. Octopaminergic agonists such as for example amitraz. Site III electron transport inhibitors/site II electron transport inhibitors such as for example hydramethylnon; acequinocyl; fluacrypyrim; or cyflumetofen and cyenopyrafen. Electron transport inhibitors such as for example Site I electron transport inhibitors, from the group of the METI acaricides, e.g. fenazaquin, fenpyroximate, pyrimidifen, pyridaben, tebufenpyrad, tolfenpyrad, and rotenone; or voltage-dependent sodium channel blockers, e.g. indoxacarb and metaflumizone. Fatty acid biosynthesis inhibitors such as for example tetronic acid derivatives, e.g. spirodiclofen and spiromesifen; or tetramic acid derivatives, e.g. spirotetramat. Neuronal inhibitors with unknown mechanism of action, e.g. bifenazate. Ryanodine receptor effectors such as for example diamides, e.g. flubendiamide, (R),(S)-3-chloro-N1-{2-methyl-4-[1,2,2,2-tetrafluoro-1-(trifluoromethyl)ethyl]phenyl}-N2-(1-methyl-2-methylsulphonylethyl)phthalamide, chlorantraniliprole (Rynaxypyr), or Cyazypyr. Further active ingredients with unknown mechanism of action such as for example amidoflumet, benclothiaz, benzoximate, bromopropylate, buprofezin, chinomethionat, chlordimeform, chlorobenzilate, clothiazoben, cycloprene, dicofol, dicyclanil, fenoxacrim, fentrifanil, flubenzimine, flufenerim, flutenzin, gossyplure, japonilure, metoxadiazone, petroleum, potassium oleate, pyridalyl, sulfluramid, tetrasul, triarathene or verbutine; or one of the following known active compounds 4-{[(6-brompyrid-3-yl)methyl](2-fluorethyl)amino}furan-2(5H)-on (known from WO 2007/115644), 4-{[(6-fluorpyrid-3-yl)methyl](2,2-difluorethyl)amino}furan-2(5H)-on (known from WO 2007/115644), 4-{[(2-chlor-1,3-thiazol-5-yl)methyl](2-fluorethyl)amino}furan-2(5H)-on (known from WO 2007/115644), 4-{[(6-chlorpyrid-3-yl)methyl](2-fluorethyl)amino}furan-2(5H)-on (known from WO 2007/ 115644), 4-{[(6-chlorpyrid-3-yl)methyl](2,2-difluorethyl)amino}furan-2(5H)-on known from WO 2007/115644), 4-{[(6-chlor-5-fluorpyrid-3-yl)methyl](methyl)amino}furan-2(5H)-on (known from WO 2007/115643), 4-{[(5,6-dichlorpyrid-3-yl)methyl](2-fluorethyl)amino}furan-2(5H)-on (known from WO 2007/115646), 4-{[(6-chlor-5-fluorpyrid-3-yl)methyl](cyclopropyl)amino}furan-2(5H)-on (known from WO 2007/115643), 4-{[(6-chlorpyrid-3-yl)methyl](cyclopropyl)amino}furan-2(5H)-on (known from EP-A-0 539 588), 4-{[(6-chlorpyrid-3-yl)methyl](methyl)amino}furan-2(5H)-on (known from EP-A-0 539 588), [(6-chlorpyridin-3-yl)methyl](methyl)oxido-λ4-sulfanylidencyanamid (known from WO 2007/149134), [1-(6-chlorpyridin-3-yl)ethyl](methyl)oxido-λ4-sulfanylidencyanamid (known from WO 2007/149134) and its diastereomeres (A) and (B)

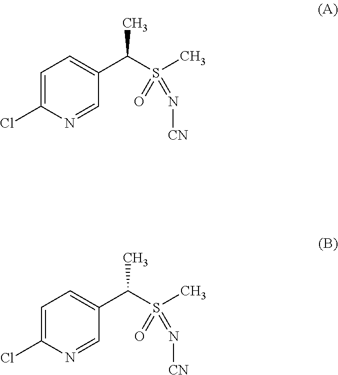

(also known from WO 2007/149134), [(6-trifluormethylpyridin-3-yl)methyl](methyl)oxido-2A-sulfanylidencyanamid (known from WO 2007/095229), or [1-(6-trifluormethylpyridin-3-yl)ethyl](methyl)oxido-λ4-sulfanylidencyanamid (known from WO 2007/149134) and its diastereomeres (C) and (D)

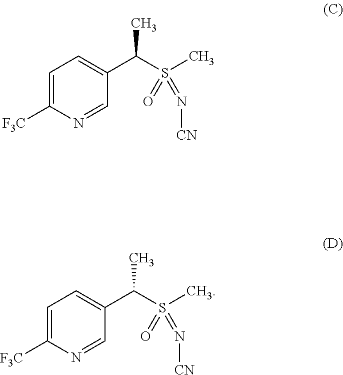 [SMILES: C[C@H](c1ccc(C(F)(F)F)nc1)S(C)(=O)=NC#N ; C[C@@H](c1ccc(C(F)(F)F)nc1)S(C)(=O)=NC#N]

(also known from WO 2007/149134).

In another preferred embodiment of the present invention the organic biocide is selected from the group comprising acetamide and anilide fungicides, aliphatic nitrogen fungicides, aromatic fungicides, thiocarbamate fungicides, oxazol fungicides, organophosphorous fungicides, phatlimid fungicides, strobillurin fungicides, urea derivative fungicides, quaternary ammonium antiseptic compounds, quaternary ammonium related antiseptic compounds like chlorhexidine gluconate, polyhexamethylene biguanide hydrochloride, octenidine dihydrochloride and/or mixtures thereof.

Particular fungicides according to the present invention are selected from the group comprising inhibitors of the nucleic acid synthesis such as for example benalaxyl, benalaxyl-M, bupirimate, clozylacon, dimethirimol, ethirimol, furalaxyl, hymexazol, mefenoxam, metalaxyl, metalaxyl-M, ofurace, oxadixyl and oxolinic acid. Inhibitors of the mitosis and cell division such as for example benomyl, carbendazim, chlorfenazole, diethofencarb, ethaboxam, fuberidazole, profenofos, pencycuron, thiabendazole, thiophanate, thiophanate-methyl and zoxamide. Inhibitors of the respiration such as for example diflumetorim as CI-respiration inhibitor; bixafen, boscalid, carboxin, fenfuram, flutolanil, fluopyram, furametpyr, furmecyclox, mepronil, oxycarboxin, penthiopyrad, thifluzamide as CII-respiration inhibitor; amisulbrom, azoxystrobin, cyazofamid, dimoxystrobin, enestrobin, famoxadone, fenamidone, fluoxastrobin, kresoxim-methyl, metominostrobin, orysastrobin, picoxystrobin, pyraclostrobin, pyribencarb, trifloxystrobin as CIII-respiration inhibitor. Compounds capable to act as an uncoupler such as like for example dinocap, fluazinam and meptyldinocap Inhibitors of the ATP production such as for example fentin acetate, fentin chloride, fentin hydroxide, and silthiofam Inhibitors of the amino acid and/or protein biosynthesis such as for example andoprim, blasticidin-S, cyprodinil, kasugamycin, kasugamycin hydrochloride hydrate, mepanipyrim and pyrimethanil Inhibitors of the signal transduction such as for example fenpiclonil, fludioxonil and quinoxyfen Inhibitors of the lipid and membrane synthesis such as for example biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl and vinclozolin Inhibitors of the ergosterol biosynthesis such as for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, viniconazole and voriconazole Inhibitors of the cell wall synthesis such as for example benthiavalicarb, dimethomorph, flumorph, iprovalicarb, mandipropamid, polyoxins, polyoxorim, validamycin A, and valiphenal. Inhibitors of the melanine biosynthesis such as for example carpropamid, diclocymet, fenoxanil, phthalide, pyroquilon and tricyclazole. Compounds capable to induce a host defence such as like for example acibenzolar-S-methyl probenazole, and tiadinil. Compounds capable to have a multisite action such as like for example Bordeaux mixture, captafol, captan, chlorothalonil, copper naphthenate, copper oxide, copper oxychloride, copper preparations such as copper hydroxide, copper sulphate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propineb, sulphur and sulphur preparations including calcium polysulphide, thiram, tolylfluanid, zineb and ziram. Further compounds like for example 3-(difluoromethyl)-1-methyl-N-[(9R)-9-(1-methylethyl)-1,2,3,4-tetrahydro-1,4-methanonaphthalen-5-yl]-1H-pyrazole-4-carboxamide, 3-(difluoromethyl)-1-methyl-N-[(9S)-9-(1-methylethyl)-1,2,3,4-tetrahydro-1,4-methanonaphthalen-5-yl]-1H-pyrazole-4-carboxamide, 3-(difluoromethyl)-N-[4′-(3,3-dimethylbut-1-yn-1-yl)biphenyl-2-yl]-1-methyl-1H-pyrazole-4-carboxamide, 2-chloro-N-(4′-prop-1-yn-1-ylbiphenyl-2-yl)pyridine-3-carboxamide, 2-chloro-N-[4′-(3,3-dimethylbut-1-yn-1-yl)biphenyl-2-yl]pyridine-3-carboxamide, 5-fluoro-1,3-dimethyl-N-(4′-prop-1-yn-1-ylbiphenyl-2-yl)-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-1-methyl-N-(4′-prop-1-yn-1-ylbiphenyl-2-yl)-1H-pyrazole-4-carboxamide, 3-(difluoromethyl)-N-[4′-(3-methoxy-3-methylbut-1-yn-1-yl)biphenyl-2-yl]-1-methyl-1H-pyrazole-4-carboxamide, N-(3-tert-butyl-2-ethenylphenyl)-1-methyl-3-(trifluoromethyl)-1H-pyrazole-4-carboxamide, 1-methyl-N-[9-(1-methylethyl)-1,2,3,4-tetrahydro-1,4-methanonaphthalen-5-yl]-3-(trifluoromethyl)-4,5-dihydro-1H-pyrazole-4-carboxamide, N-(4′-chlorobiphenyl-2-yl)-1-methyl-3-(trifluoromethyl)-4,5-dihydro-1H-pyrazole-4-carboxamide, N-[9-(dichloromethylidene)-1,2,3,4-tetrahydro-1,4-methanonaphthalen-5-yl]-3-(difluoromethyl)-1-methyl-1H-pyrazole-4-carboxamide, N-[4′-(3-cyano-3-methylbut-1-yn-1-yl)biphenyl-2-yl]-3-(difluoromethyl)-1-methyl-1H-pyrazole-4-carboxamide, rel-3-(difluoromethyl)-1-methyl-N-[(1R,4S)-4-(1-methylethyl)-1,2,3,4-tetrahydro-1,4-methanonaphthalen-5-yl]-1H-pyrazole-4-carboxamide, N-[9-(dibromomethylidene)-1,2,3,4-tetrahydro-1,4-methanonaphthalen-5-yl]-3-(difluoromethyl)-1-methyl-1H-pyrazole-4-carboxamide, rel-3-(difluoromethyl)-1-methyl-N-[(1R,4S)-9-methylidene-1,2,3,4-tetrahydro-1,4-methanonaphthalen-5-yl]-1H-pyrazole-4-carboxamide, rel-3-(difluoromethyl)-1-methyl-N-[(1R,4S)-1,2,3,4-tetrahydro-1,4-methanonaphthalen-5-yl]-1H-pyrazole-4-carboxamide, 3-(difluoromethyl)-N-[9-(difluoromethylidene)-1,2,3,4-tetrahydro-1,4-methanonaphthalen-5-yl]-1-methyl-1H-pyrazole-4-carboxamide, N-[2-(1,3-dimethylbutyl)phenyl]-5-fluoro-1,3-dimethyl-1H-pyrazole-4-carboxamide, N-{2-[1,1′-bi(cyclopropyl)-2-yl]phenyl}-3-(difluoromethyl)-1-methyl-1H-pyrazole-4-carboxamide, (2E)-2-(2-{[6-(3-chloro-2-methylphenoxy)-5-fluoropyrimidin-4-yl]oxy}phenyl)-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N-ethyl-N-methyl-N′-{2-methyl-5-(trifluoromethyl)-4-[3-(trimethylsilyl)propoxy]phenyl}imidoformamide, N-ethyl-N-methyl-N′-{2-methyl-5-(trifluoromethyl)-4-[3-(trimethylsilyl)propoxy]phenyl}imidoformamide, N′-{5-(difluoromethyl)-2-methyl-4-[3-(trimethylsilyl)propoxy]phenyl}-N-ethyl-N-methylimidoformamide, O-{1-[(4-methoxyphenoxy)methyl]-2,2-dimethylpropyl} 1H-imidazole-1-carbothioate, N-[2-(4-{[3-(4-chlorophenyl)prop-2-yn-1-yl]oxyl -3-methoxyphenyl)ethyl]-N2-(methylsulfonyl)valinamide, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, 5-chloro-7-(4-methylpiperidin-1-yl)-6-(2,4,6-trifluorophenyl)[1,2,4]triazolo[1,5-a]pyrimidine, propamocarb-fosetyl, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulfonyl)pyridine, 2-butoxy-6-iodo-3-propyl-4H-chromen-4-one, 2-phenylphenol and salts, 3-(difluoromethyl)-1-methyl-N-[2-(1,1,2,2-tetrafluoroethoxy)phenyl]-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, quinolin-8-ol, benthiazole, bethoxazin, capsimycin, carvone, chinomethionat, cufraneb, cyflufenamid, cymoxanil, dazomet, debacarb, dichlorophen, diclomezine, dicloran, difenzoquat, difenzoquat methylsulphate, diphenylamine, ecomate, ferimzone, flumetover, fluopicolide, fluoroimide, flusulfamide, fosetyl-aluminium, fosetyl-calcium, fosetyl-sodium, hexachlorobenzene, irumamycin, isotianil, methasulfocarb, methyl (2E)-2-{2-[({cyclopropyl[(4-methoxyphenyl)imino]methyl}thio)methyl]phenyl}-3-methoxyacrylate, methyl isothiocyanate, metrafenone, mildiomycin, N-(4-chloro-2-nitrophenyl)-N-ethyl-4-methylbenzenesulfonamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-difluorophenyl]methyl}-2-phenylacetamide, natamycin, nickel dimethyldithiocarbamate, nitrothal-isopropyl, octhilinone, oxamocarb, oxyfenthiin, pentachlorophenol and salts, phosphorous acid and its salts, propamocarb fosetylate, propanosine-sodium, proquinazid, pyrrolnitrine, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N′-prop-2-yn-1-ylthiophene-2-sulfonohydrazide and zarilamid, 8-hydroxyquinoline-sulphate, 2,3-dibutyl-6-chloro-thieno[2,3-d]pyrimidin-4(3H)one, chloroneb, prothiocarb, binapacryl, and cyprosulfamide.

Common names are used in accordance with the International Organization for Standardization (ISO) or the chemical names, if appropriate together with a customary code number of the compounds and always comprise all applicable forms such as acids, salts, ester, or modifications such as isomers, like stereoisomers and optical isomers.

The biocide active ingredients of the present invention may further possess asymmetric carbons, and thus encompass optical isomers. Additionally, the biocide active ingredients which may be used according to the invention can be present in different polymorphic forms or as a mixture of different polymorphic forms. Both the pure polymorphs and the polymorph mixtures are suitable according to the invention.

The biocide active ingredient which is suitable according to the invention may be formulated and/or applied with one or more additional biocide active ingredient, compound or synergist. Such combinations may provide certain advantages, such as, without limitation, exhibiting synergistic effects for greater control of insect pests, reducing rates of application of insecticide thereby minimizing any impact to the environment and to worker safety, controlling a broader spectrum of insect pests, safening of crop plants to phytotoxicity, and improving tolerance by non-pest species, such as mammals and fish. Additional compounds include, without limitation, other pesticides, plant growth regulators, fertilizers, soil conditioners, or other agricultural chemicals. Synergists are compounds which increase the action of the biocide active ingredient, without it being necessary for the synergistic agent added to be active itself

Some of the biocide active ingredients which are suitable according to the invention act not only against plant, hygiene and stored product pests, but also in the veterinary medicine sector against animal parasites (ecto- and endoparasites), such as hard ticks, soft ticks, mange mites, leaf mites, flies (biting and licking), parasitic fly larvae, lice, hair lice, feather lice and fleas.

Some of the biocide active ingredients which are suitable according to the invention also have a strong insecticidal action against insects which destroy industrial materials. Industrial materials in the present connection are to be understood as meaning non-living materials, such as, preferably, plastics, adhesives, sizes, papers and cardboards, leather, wood and processed wood products and coating compositions.

In another preferred embodiment the composite material of the present invention comprises at least one biocide active ingredient that is efficient against insecticidal action of insects which destroy the base polymer.

The biocide active ingredients which are suitable according to the invention can likewise be employed for protecting composite materials which come into contact with seawater or brackish water, such as hulls, screens, nets, buildings, moorings and signalling systems, against fouling.

Furthermore, some of the biocide active ingredients which are suitable according to the invention, alone or in combinations with other active compounds, may be employed as antifouling agents.

Most preferably, the biocide active ingredient of the present invention is a non-liquid non-oil substance at room temperature with low volatility whereby the substance can be solid or can be formulated as a substance in solid form. The choice of such substances improves the release controllability and the storage stability of the polymer composite material. Especially, essential oils as biocide active ingredients should be avoided because of the difficulty to provide a stable dispersion in the polymer layer without exudation of the biocide. Furthermore, the mechanical stability of the polymer composite material could be deterred in the production process due to bubble wrap and the like if liquids or substances with high volatility would be incorporated.

As already shortly mentioned above, a polymer composite material according to present invention or a product obtained by a method according to the present invention can be preferably used in agriculture and/or horticulture.

Especially the use as mulch film, fumigation film, or as propagation film is preferred.

Alternatively, a polymer composite material according to present invention or a product obtained by a method according to the present invention can be used as propagation pots nursery trays, and/or harvest trays.

The invention also relates to mulch film, fumigation film, propagation film, propagation pots, nursery trays and/or harvest trays comprising a polymer composite material as discussed herein.

In a further aspect of the present invention there is provided a method for protecting crop plants from harmful organisms, comprising the step of covering one or more of the plants with the polymer composite material according to the present invention with biocide functionality.

The term “crop plants” as used herein means any kind of agricultural crop, inclusing but not limited to cereals, rice, legumes, cotton, tobacco, vegetables and fruit plants. Preferred are high value crops like vegetables, fruit plants and plants for beverage, pharmaceutical and tobacco industry and plants from which e.g. natural dyestuffs and natural compounds for applications in cosmetics, cleaning and caring formulations or further chemical dn/or biotechnological processing are won.

1. A polymer composite material with biocide functionality comprising at least one supporting layer and one layer comprising one or more biocide active ingredients, wherein the polymer composite material is made by a blown film extrusion process and further wherein the biocide is added to the blown film extrusion process as a premix to prevent thermal degradation of the biocide.

2. A polymer composite material according to claim 1, wherein the polymer materials of the layers is selected from the group consisting of polyethylene terephthalate, polyvinyl chloride, polyolefins, polypropylene, polystyrene, polyester, polyether, polyacrylate, polycarbonate, polyamide and polyurethane

3. A polymer composite material according to claim 1, wherein polymer material of the supporting layer is HDPE and the polymer material of one or more layers comprising biocide active ingredients is LDPE, LLDPE or blends of LDPE and LLDPE.

4. A polymer composite material according to claim 1, wherein the polymer composite material has two layers, one layer being a supporting layer and/or a barrier layer and the other layer comprising one or more biocide active ingredients.

5. A polymer composite material according to claim 1, wherein the polymer composite material has three layers, an inner layer being a supporting layer and/or a barrier layer and one outer layer comprising one or more biocide active ingredients.

6. A polymer composite material according to claim 1, wherein the polymer composite material has three layers, an inner layer being a supporting layer and/or a barrier layer and both outer layers comprising one or more biocide active ingredients.

7. A method for production of a polymer composite material according to claim 1, comprising coextruding at least a first polymer and a second polymer through a single extrusion head and/or die, whereas air is injected through a hole in a center of the die, and expanding extruded melt into a bubble, whereas at least one polymer comprises at least one biocide active ingredient.

8. A polymer composite material according to claim 1 that is capable of being used in agriculture and/or horticulture.

9. A composite material according to claim 8 comprising mulch film, fumigation film, propagation film, propagation pots, nursery trays and/or harvest trays.

10. Mulch film, fumigation film, propagation film, propagation pots, nursery trays and/or harvest trays comprising a polymer composite material according to claim 1.

11. A method for protecting crop plants from harmful organisms, comprising covering one or more plants with a polymer composite material according to claim 1.
